(19) United States
(12) Patent Application Publication
(10) Pub. No.: US 2024/0272455 A1
(43) Pub. Date: Aug. 15, 2024

(54) Lens Systems

(71) Applicant: Apple Inc., Cupertino, CA (US)

(72) Inventors: Samuel Steven, Cupertino, CA (US); Joshua J. Siegel, Woodside, CA (US); Gregory L. Tice, Cupertino, CA (US); Patrick R. Gill, Victoria (CA)

(21) Appl. No.: 18/431,345

(22) Filed: Feb. 2, 2024

Related U.S. Application Data
(60) Provisional application No. 63/484,583, filed on Feb. 13, 2023.

(51) Int. Cl. G02C 7/06; G02B 26/08; G02C 7/08

(52) U.S. Cl. CPC G02C 7/063; G02B 26/0875; G02C 7/083

(57) ABSTRACT

A lens system may include overlapping lenses that shift laterally with respect to each other to provide vision correction. The lens system may include first and second lenses that include one or more freeform surfaces and one or more non-freeform surfaces. One or more of these lens surfaces may provide adjustable presbyopic vision correction and/or a static distance vision correction.

This application claims the benefit of U.S. provisional patent application No. 63/484,583, filed Feb. 13, 2023, which is hereby incorporated by reference herein in its entirety.

### FIELD

This relates generally to optical systems and, more particularly, to one or more lenses in optical systems.

### BACKGROUND

Eyewear may include optical systems such as lenses. For example, eyewear such as a pair of glasses may include lenses through which a user views the surrounding environment.

It can be challenging to design devices with lenses. If care is not taken, the optical system in these devices may not be able to accommodate various eye conditions, may generally not perform satisfactorily, and/or may be excessively bulky.

### SUMMARY

A head-mounted device such as a pair of glasses may include left and right lens systems received within left and right openings of a head-mounted housing frame. The left and right lens systems may overlap left and right eye boxes, allowing left and right eyes received at the left and right eye boxes to view objects through the left and right lens systems. Each lens system may include first and second lenses configured to shift or move laterally (in directions non-parallel or perpendicular to the viewing direction) with respect to each other using one or more actuators.

The first and second lenses may each include a freeform surface and a non-freeform surface. These surfaces of the first and second lenses may provide presbyopic vision correction and/or ametropic vision correction (e.g., myopic vision correction, hyperopic vision correction, astigmatic vision correction, etc.). The freeform surfaces of the first and second lenses may provide an adjustable presbyopic vision correction component when the first and second lenses are in one or more offset states by introducing an adjustable added optical power (associated with the degree of lateral shift of the freeform surfaces relative to each other). Any single or combination of the surfaces of the first and second lenses may be used to provide a base or static optical power as an ametropic vision correction component in both the aligned state and the offset state(s).

If desired, the configuration of the lens system (e.g., which of the two lenses is moved, the cylinder component of one or both lenses, and/or other configurations of the lens system) may be implemented to mitigate or reduce undesired dynamic prism (the change in prism field versus depth) associated with lateral lens movement and offset lens vertices (e.g., to a desired or acceptable amount of dynamic prism).

If desired, the freeform surface(s) of one or both of the first and second lenses may be obtained by tuning the freeform surface of an initial lens blank to exhibit a large optical aperture (e.g., to facilitate the formation of lenses for different interpupillary distances), to exhibit symmetry relative to a horizontal line bisecting the lens, and/or exhibit other desired characteristics.

### BRIEF DESCRIPTION OF THE DRAWINGS

FIG. 1 is a diagram of an illustrative system that includes adjustable lenses in accordance with some embodiments.

FIGS. 2A and 2B are side views of different states of an illustrative adjustable lens system that includes lenses movable relative to each other to provide an adjustable optical power in accordance with some embodiments.

FIG. 3 is a front view of adjustable lenses for left and right optical systems that each provide an adjustable optical power in accordance with some embodiments.

FIGS. 4A and 4B are side views of different states of an illustrative lens system having freeform surfaces configured to exhibit an optical power when offset for near distance viewing.

FIGS. 5A and 5B are side views of different states of an illustrative lens system having freeform surfaces and a concave back surface to provide a base optical power and an adjustable optical power in accordance with some embodiments.

FIGS. 6A and 6B are side views of different states of an illustrative lens system having freeform surfaces and a convex back surface to provide a base optical power and an adjustable optical power in accordance with some embodiments.

FIG. 7 is a side view of an illustrative lens system having freeform surfaces and a convex front surface to provide a base optical power and an adjustable optical power in accordance with some embodiments.

FIG. 8 is a side view of an illustrative lens system having freeform surfaces, a convex front surface, and a concave back surface to provide a base optical power and an adjustable optical power in accordance with some embodiments.

FIG. 9 is a side view of an illustrative lens system having freeform surfaces to provide a base optical power and an adjustable optical power in accordance with some embodiments.

FIGS. 10A and 10B are side views of different states of an illustrative lens system configured to perform dynamic prism correction in accordance with some embodiments.

FIG. 11 is a side view of an illustrative lens system coupled to an actuating system in accordance with some embodiments.

### DETAILED DESCRIPTION

An optical or lens system may include two overlapping lenses (e.g., lens plates). One or both lenses may be movable laterally with respect to the other lens to adjust the optical power of the optical system. The lenses may include freeform surfaces (e.g., as opposing surfaces on respective lenses that face each other, as front and back surfaces of the lenses, etc.). In particular, when the lenses are in an offset state relative to each other, the freeform surfaces may help facilitate presbyopic vision correction or generally converge (e.g., collimate) light that emanates from a near distance or light from near distance objects that passes through the lenses.

In some arrangements, one or both lenses may include an ametropic vision correction component. As examples, the ametropic vision correction component may be formed from a front surface of the first lens, a back surface of the second lens, the freeform surface of the first lens and/or the freeform surface of the second lens. Accordingly, when such lenses are in an aligned state relative to each other, the optical system may exhibit an optical power for ametropic vision correction (e.g., an optical power for myopic or hyperopic correction and/or a cylinder component and a corresponding axis for the cylinder component for astigmatic correction). When such lenses are in an offset state relative to each other, the optical system may exhibit an additional optical power for presbyopic vision correction in combination with the base optical power for ametropic vision correction.

The lenses may be configured to mitigate dynamic prism effects associated with laterally offsetting curved surface vertices of the lenses when switching from the aligned state to the offset state. Dynamic prism may be characterized as the change in the prism field versus depth. As examples, the cylinders of the freeform surface(s) of the lens(es) may be configured to introduce an opposing prism and/or a smaller optical power (characterized by smaller surface curvature) may be provided on a moving lens while a larger optical power may be provided on a lens fixed in position when switching from the aligned state to the offset state. If desired, rather than eliminating dynamic prism effects entirely, the lenses may be configured to provide a reduced amount of dynamic prism (e.g., to match a specific user's convergence versus depth characteristic, to correspond to a preference set by user input and/or predetermined based on average user preferences, etc.).

Configurations in which left and right optical or lens systems are provided for and overlap left and right eye boxes in a head-mounted device such as a pair of eyeglasses are sometimes described herein as an example. A set of overlapping lens plates may be provided for each optical system. In these configurations, the surface patterns of a lens in each of the optical systems may exhibit symmetry with respect to a horizontal line bisecting the lens. By exhibiting this type symmetry, base lenses (e.g., initial lens blanks) having the same surface pattern may be used for both left and right optical systems (with mirrored lens edge profiles). Surfaces of these base lenses may provide a lens aperture (in horizontal and vertical directions) that is greater than 45 mm, greater than 50 mm, greater than 60 mm, etc., such that different edge profiles for accommodating different lens sizes and/or different interpupillary distances may be obtained from the same base lenses.

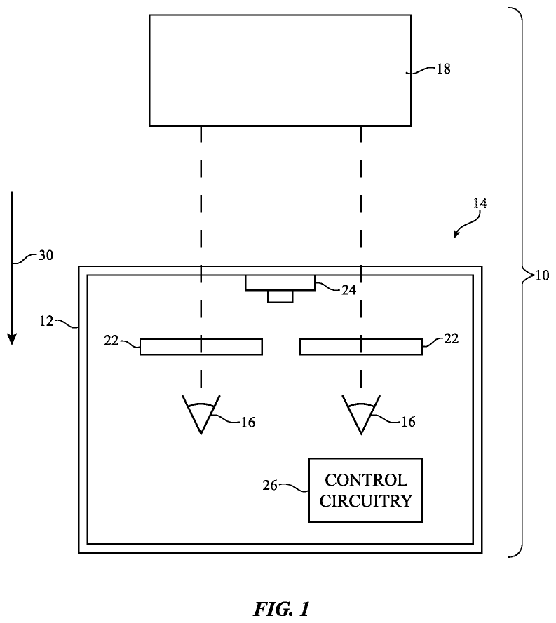

An illustrative system having a device with one or more adjustable optical elements (e.g., adjustable overlapping lens plates in each of left and right optical systems) is shown in FIG. 1. System 10 may include a head-mounted device such as eyeglasses 14 (sometimes referred to as glasses 14 or head-mounted device 14). Glasses 14 may include one or more optical systems such as adjustable lens components 22 mounted in a support structure such as support structure 12. Structure 12 may have the shape of a pair of eyeglasses (e.g., include a supporting frame), may have the shape of goggles, may form a housing having a helmet shape, or may have other configurations to help in mounting, securing, and/or generally placing the components of glasses 14 on the head of a user. Accordingly, structure 12 may sometimes be referred to herein as a head mounted or head-mountable support structure or a head mounted or head-mountable housing (structure). As an example, support structure 12 may include a frame with left and right openings that receive left and right sets of lens components 22. Left and right frame portions may be coupled by a bride or bridging portion (e.g., configured to rest on a nasal region of a wearer). Support structure 12 may include left and right temples coupled to left and right frame portions, respectively. Left and right opening in the frame and left and right sets of lens components 22 may overlap respective left and right eye boxes.

Adjustable lens components 22 may form lenses that allow a viewer (e.g., a viewer having eyes 16) to view one or more external objects such as object 18 in the surrounding environment. In other words, light rays (e.g., environmental light, reflected light, etc.) from object 18 may be conveyed in direction 30 and received by eyes 16 at respective eye boxes of head-mounted device 12 through components 22. Glasses 14 may include one or more adjustable lens components 22, each aligned with a respective one of a user's eyes 16 and each overlapping a respective one of an eye box (sometimes referred to as an eye position). As an example, lens components 22 may include one or more left lenses aligned with a left eye box and therefore configured to overlap a viewer's left eye and may include one or more right lenses aligned with a right eye box and therefore configured to overlap a viewer's right eye. This is, however, merely illustrative. If desired, glasses 14 may include adjustable lens components 22 for a single eye or a single eye box.

Adjustable lens components 22 may be corrective lenses that correct for vision defects. For example, eyes 16 may have vision defects such as myopia, hyperopia, presbyopia, astigmatism, higher-order aberrations, and/or other vision defects. Corrective lenses such as those of lens components 22 may be configured to correct for these vision defects. Lens components 22 may be adjustable to accommodate users with different vision defects and/or to accommodate different focal ranges. For example, lens components 22 may have a first set of optical characteristics for a first user having a first prescription and a second set of optical characteristics for a second user having a second prescription. Glasses 14 may be used purely for vision correction (e.g., glasses 14 may be a pair of spectacles) or glasses 14 may include displays that display virtual reality or augmented reality content (e.g., glasses 14 may be a head-mounted display). In virtual reality or augmented reality systems, adjustable lens components 22 may be used to move content between focal planes from the perspective of the user. Arrangements in which glasses 14 are spectacles that do not include displays are sometimes described herein as an illustrative example.

Glasses 14 may include control circuitry 26. Control circuitry 26 may include processing circuitry such as microprocessors, digital signal processors, microcontrollers, baseband processors, image processors, application-specific integrated circuits with processing circuitry, and/or other processing circuitry and may include random-access memory, read-only memory, flash storage, hard disk storage, and/or other storage (e.g., a non-transitory storage media for storing computer instructions for software that runs on control circuitry 26).

Glasses 14 may include input-output circuitry such as eye state sensors, range finders disposed to measure the distance to external object 18, touch sensors, gesture sensors, buttons, microphones to gather voice input and other input, other sensors, and other devices that gather input (e.g., user input from the viewer having eyes 16) and may include light-emitting diodes, displays, speakers, and other devices for providing output (e.g., output for the viewer having eyes 16). Glasses 14 may, if desired, include wireless circuitry and/or other circuitry to support communications with a computer or other external equipment. If desired, a sensor system such as sensor system 24 may be used to gather input during use of glasses 14. Sensor system 24 may include an accelerometer, compass, an ambient light sensor or other light detector, a proximity sensor, a scanning laser system, and other sensors for gathering input during use of glasses 14. Sensor system 24 may be used to track a user's eyes 16. For example, sensor system 24 may include one or more digital image sensors, lidar (light detection and ranging) sensors, ultrasound sensors, or other suitable sensors for tracking the location of a user's eyes. As an example, sensor system 24 may be used by control circuitry 26 to gather images of the pupils and other portions of the eyes of the viewer. The locations of the viewer's pupils and the locations of the viewer's pupils relative to specular glints from light sources with known positions or the rest of the viewer's eyes may be used to determine the locations of the centers of the viewer's eyes (i.e., the centers of the user's pupils) and the direction of view (gaze direction) of the viewer's eyes. In some arrangements, sensor system 24 may include a wavefront sensor that measures the aberrations of a user's eyes. Control circuitry 26 may then adjust the optical properties of lens components 22 to correct the user-specific aberrations detected by the wavefront sensor.

Control circuitry 26 may also control the operation of optical elements such as adjustable lens components 22. Each set of adjustable lens components 22 (e.g., that overlaps a left eye box and/or that overlaps a right eye box) may sometimes be referred to as a set of adjustable or tunable lenses, an (adjustable) lens system, an (adjustable) optical system, an optical or lens module, an optical or lens assembly, or an (adjustable) lens device. In some illustrative arrangements described herein as an example, each of right and left lens systems 22 may include multiple lenses that are movable with respect to each other (e.g., laterally in a direction non-parallel to or perpendicular to direction 30). A lens shaping component such as one or more actuators (e.g., one or more stepper motors, piezoelectric actuators, motors, linear electromagnetic actuators, and/or other electronic components that apply a force) may be used to adjust the relative placement (location) of these multiple lenses to affect the optical properties imparted by each lens system 22 in response to one or more control signals from control circuitry 26.

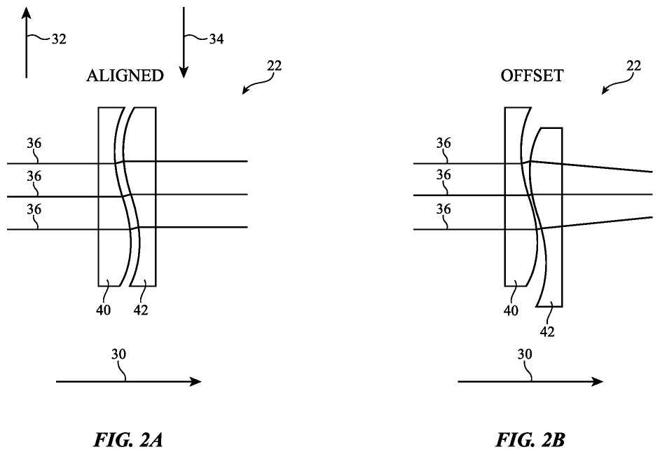

FIGS. 2A and 2B show an illustrative lens system 22 (e.g., a left lens system for a user's left eye or a right lens system for a user's right eye) that includes a first lens 40 and a second lens 42. Lenses 40 and 42 may be adjustable lens components that collectively form an Alvarez lens. Lenses 40 and 42 (sometimes referred to as lens plates) may have one or more freeform surfaces (e.g., cubic surfaces, surfaces defined by other polynomial functions, and/or generally a surface that is not translationally and/or rotationally symmetric, e.g., about axes normal to a mean plane of the surface) and one or more non-freeform surfaces such as concave (spherical, aspherical, toric or toroidal, and atoric or atoroidal) surfaces, convex (spherical, aspherical, toric or toroidal, and atoric or atoroidal) surfaces, and planar (e.g., nominally planar or minimally curved) surfaces. Lenses 40 and 42 may each be formed from polycarbonate, a urethane-based monomer or polymer, and/or other suitable types of lens material. If desired, a high-index material (e.g., having a refractive index greater than 1.55, greater than 1.6, greater than 1.65, greater than 1.7, etc.) may be used in forming lenses 40 and 42 to reduce lens thickness and/or reduce (lateral) translation range.

As described herein, surfaces of a given lens (e.g., lenses 40 and/or 42) may refer to the pair of opposite surfaces through which light passes from a surrounding environment to eye boxes and therefore the user's eyes. One or both of the pair of surfaces may provide optical properties (e.g., surface features or patterns) that define the optical function of the lens. These surfaces may be surrounded by an edge or edge face(s) defined by an edge profile that connect the pair of opposite surfaces on lateral sides. The above-mentioned environmental light that reaches the eye boxes may not necessarily pass through the edge face(s).

One or both of lenses 40 and 42 may be movable laterally with respect to each other (e.g., in directions 32 and 34, in directions into and out of the page, and/or in other directions in the same plane to which a vector aligned to direction 30 is orthogonal). Control circuitry 26 may be used to apply one or more control signals to one or more actuators (e.g., one or more stepper motors, piezoelectric actuators, motors, linear electromagnetic actuators, and/or other electronic components that apply a force) to thereby change the position of one or both of lenses 40 and 42 relative to each other (e.g., to move lens 40 in an upward direction 32 while lens 42 is stationary, to move lens 42 in a downward direction 34 while lens 40 is stationary, to move lens 40 in an upward direction 32 while moving lens 42 in a downward direction 34, etc.).

By offsetting or changing the relative positions of lenses 40 and 42 (e.g., by moving from the configuration in FIG. 2A to the configuration in FIG. 2B), the optical power of the lenses or lens plates 40 and 42 may be adjusted. In the example of FIG. 2A, when lenses 40 and 42 are positioned in a first configuration (e.g., in a first aligned state) in which corresponding freeform surfaces of lenses 40 and 42 and lenses 40 and 42 themselves are aligned, light 36 passing through lenses 40 and 42 in direction 30 may not be imparted with any optical power (e.g., collimated light is passed through and output). In other words, the lens system in the configuration of FIG. 2A provides no optical power (e.g., provides a nominal first optical power) for light 36 as viewed by an eye in an eye box behind lens components 22.

The aligned state of FIG. 2A may generally be referred to as a first alignment state between lenses 40 and 42 in which the wavefront transmitted by lens 40 reaches corresponding first locations on lens 42 such that the first optical power (e.g., no optical power, or a base optical power in other embodiments described herein) is imparted through lenses 40 and 42. While edges of lenses 40 and 42 are shown in the example of FIG. 2A to be aligned in this first alignment state, this is merely illustrative. If desired, the edge profiles of lenses 40 and 42 may not necessarily match and/or the lens edges of lenses 40 and 42 may be offset to achieve the optical functionality described in connection with this first alignment state.

In the example of FIG. 2B, when lenses 40 and 42 are positioned in a second configuration (e.g., in a second offset state) in which corresponding middle freeform surfaces of lenses 40 and 42 and lenses 40 and 42 themselves are offset (e.g., via a lateral translation along an axis parallel to directions 32 and 34), light 36 passing through lenses 40 and 42 in direction 30 may be imparted with a positive optical power (e.g., converging light is output). In other words, the lens system in the configuration of FIG. 2B provides a positive optical power (e.g., provides a second optical power different than the first nominal optical power) for light 36 as viewed by the eye in the eye box behind lens components 22.

The offset state of FIG. 2B may generally be referred to as a second alignment state between lenses 40 and 42 in which the wavefront transmitted by lens 40 reaches corresponding second locations (different than the above-mentioned first locations) on lens 42 such that the second optical power (e.g., an adjustable power component in combination with the above-mentioned first optical power) is imparted through lenses 40 and 42. While edges of lenses 40 and 42 are shown in the example of FIG. 2B to be offset in this second alignment state, this is merely illustrative. If desired, the edge profiles of lenses 40 and 42 may not necessarily be offset and/or the lens edges of lenses 40 and 42 may be aligned to achieve the optical functionality described in connection with this second alignment state. Multiple other alignment states may be used to provide varying levels of adjustable power component.

If desired, when lenses 40 and 42 are positioned in other corresponding configurations, the lens system may exhibit varying degrees of positive optical power and/or varying degrees of negative optical power (e.g., diverging light is output). These examples are merely illustrative. If desired, other lens shapes may be provided and/or other corresponding optical powers may be created by moving lenses 40 and 42 into the appropriate positions.

To further improve optical performance, one or more freeform surfaces of lenses 40 and 42 may be formed using surfaces defined by functions containing higher-order polynomials such as polynomials having terms greater than the second-order terms (e.g., polynomials having third-order polynomial terms, fourth-order polynomial terms, fifth-order polynomial terms, etc.).

By forming one or more freeform surfaces of lenses 40 and 42 using higher-order polynomials or generally tuning the freeform surface(s), lenses 40 and 42 (e.g., lenses in the lens system in FIGS. 2A and 2B and generally the lens systems described herein) may be configured to exhibit an increased field of view (e.g., a gaze field of view along a horizontal dimension that is greater than 20 degrees, greater than 30 degrees, greater than 40 degrees, greater than 55 degrees, greater than 60 degrees, greater than 65 degrees, greater than 70 degrees, greater than 75 degrees, etc., and along a vertical dimension that is greater than 20 degrees, greater than 30 degrees, greater than 40 degrees, greater than 55 degrees, greater than 60 degrees, greater than 65 degrees, greater than 70 degrees, greater than 75 degrees, etc.).

By forming one or more freeform surfaces of lenses 40 and 42 using higher-order polynomials or generally tuning the freeform surfaces(s), lenses 40 and 42 (e.g., lenses in the lens system in FIGS. 2A and 2B and generally the lens systems described herein) may be configured to exhibit a reduced translational range (e.g., the amount of lateral lens translation with respect to each other to provide a particular optical power). As examples, a (maximum) lateral translational range of less than 10 mm, less than 8 mm, less than 5 mm, less than 4.5 mm, less than 4 mm, less than 3.5 mm, etc., may allow lenses 40 and 42 to provide optical power range (between the aligned and maximum offset states) of 1.0 D (diopter), 2.0 D, 3.0 D, 3.5 D, 4.0 D, greater than 4.0 D, etc.

By forming one or more freeform surfaces of 40 and 42 using higher-order polynomials or generally tuning the freeform surface(s) (and/or other surfaces of lenses 40 and 42), lenses 40 and 42 (e.g., lenses in the lens system in FIGS. 2A and 2B and generally the lens systems described herein) may be configured to exhibit a reduced overall lens assembly thickness (e.g., the thickness of the lens stack as measured along direction 30). As examples, the lens (assembly) thickness may be less than 6 mm, less than 5 mm, less than 4 mm, etc.

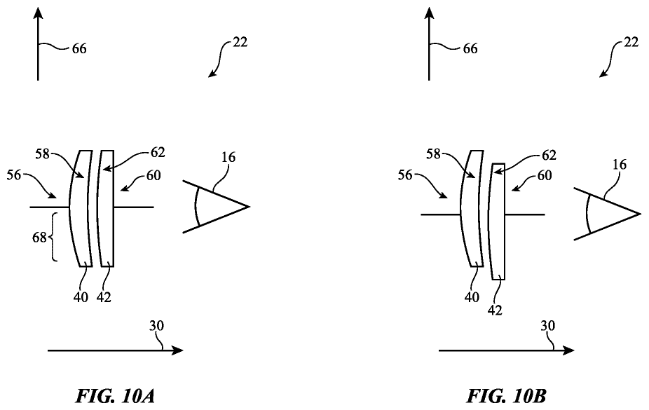

Prism may be (undesirably) introduced if the non-freeform surface or freeform surface of the moving lens (e.g., lens 40 or lens 42) has a curvature and is laterally translated with respect to the other (static) lens (e.g., lens 42 or lens 40). If desired, prism correction may be provided by modifying the quadratic terms and/or spherical component of the function defining the freeform surface(s) of corresponding lenses 40 and/or 42. If desired, the cylinder components of lenses 40 and 42 may be tuned (e.g., using the freeform or non-freeform surface(s)) to mitigate the undesired dynamic prism introduced by the lateral translation (e.g., by introducing opposing prism that counteracts the dynamic prism). An illustrative configuration for dynamic prism correction is further detailed in connection with FIG. 10.

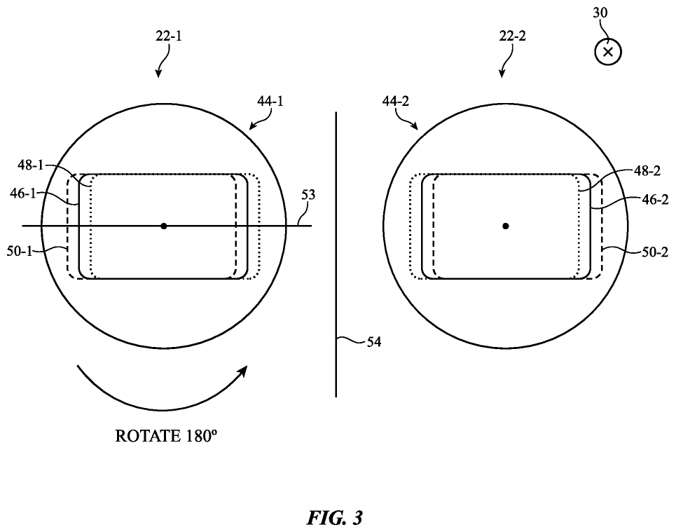

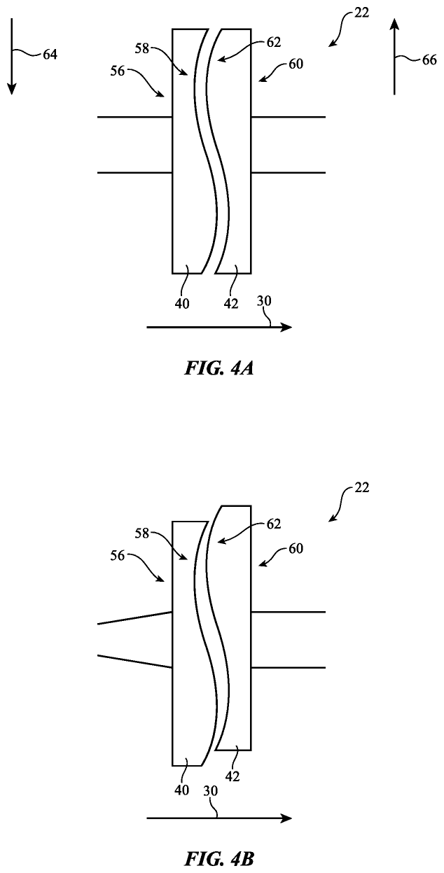

FIG. 3 is a diagram of illustrative left and right lens systems (e.g., left and right sets of lens components 22 for the head-mounted device in FIG. 1). Each of left lens system 22-1 and right lens system 22-2 may form and/or include a lens (stack) that overlaps a corresponding eye box in head-mounted device 14. As examples, the lens (stack) may be formed from lenses 40 and 42 of the type described in connection with FIGS. 2A and 2B, formed from lenses 40 and 42 of the type described in connection with FIGS. 4-11, and/or other types of lenses.

A single illustrative lens is shown for each lens system 22 in FIG. 3. However, as described herein, each lens system 22 may include at least two overlapping lenses or two lens plates 40 and 42. Each of lenses 40 and 42 may be configured in the manner described in connection with FIG. 3.

Various types of lenses 40 (or lenses 42) may be formed from an initial (e.g., circular) lens 44 (sometimes referred to herein as a lens blank or a semi-finished blank). A lens edge profile (e.g., a selected one of edge profiles 46, 48, and 50) indicated within the initially circular lens 44 forms the actual edge of lens 40 (or lens 42) with the remaining portions of the initial lens 44 outside of the edge profile being removed or cut away. Because the freeform surface of the initial lens 44 is configured (e.g., by tuning the polynomial function defining the freeform surface) to exhibit a relatively large gaze field of view, different sizes of lens 40 (or lens 42) having different edge profiles may be obtained from the same initial lens 44.

As shown in FIG. 3, from the same initial lens 44, multiple types of lenses 40 (or lenses 42) may be obtained based on different lens edge profiles 46, 48, and 50 to accommodate different inter-pupillary distances when lens 40 (or lens 42) are provided within head-mounted device 14. As examples, lenses 40 (or lenses 42) with an average inter-pupillary distance edge profile 46, a smaller-than-average inter-pupillary distance edge profile 48, a larger-than-average inter-pupillary distance edge profile 50, or generally other suitable types of edge profiles, may be formed from the same initial lens 44 with a freeform surface that exhibits a relatively large gaze field of view (e.g., a clear lens aperture across an area overlapping each of the edge profiles).

If desired, the freeform surfaces of the initial lenses 44-1 and 44-2 may exhibit symmetry to facilitate their use as the initial lens in both right and left optical systems 22-1 and 22-2. As shown in FIG. 3, the freeform surface of the left initial lens 44-1 may exhibit symmetry across line 53 overlapping the center of lens 44-1 (e.g., a plane extending from line 53 into and out of the page). In other words, top and bottom halves of lens 44-1 may have symmetric freeform surface patterns across line 53. Right initial lens 44-2 may exhibit similar symmetric properties. Consequently, the resulting lens plates 40 or 42 after being cut from these initial lenses may also have symmetric portions with respect to the respective horizontal lines (e.g., with respect to line 53 for a lens 40 or 42 having one of edge profiles 46-1, 48-1, or 50-1).

Configured in this manner, when lens 44-1 is rotated by 180 degrees (clockwise or counterclockwise), lens 44-1 would have the same mirrored (freeform) surface pattern as lens 44-2, and the initial lenses 44-1 and 44-2 for left and right optical systems 22-1 and 22-2 may be used interchangeably (e.g., after being rotated by 180 degrees). In other words, the initial lens 44-2 for the right optical system lens may be rotated by 180 degrees and cut according to one of edge profiles 46-1, 48-1, or 50-1 for left optical system lens to form a lens for left optical system 22-1, and vice versa.

When left and right optical system lenses are produced from the same initial lens exhibiting this type of symmetry, (freeform) surface patterns of the resulting left and right lenses having respective edge profiles 46-1 and 46-2 (or profiles 48-1 and 48-2, or profiles 50-1 and 50-2) when mounted in the head-mounted housing (e.g., a glasses frame) may also be symmetric across line 54 (e.g., a plane extending from line 54 into and out of the page).

In general, lenses 40 and 42 may include middle freeform surfaces facing each other and may include (front and back) non-freeform surfaces facing away from each other. Lenses 40 and 42 may be configured to provide an adjustable optical power (e.g., adjustable by relative lateral movement(s) between lenses 40 and 42) using the freeform surfaces. If desired, this adjustable optical power may be provided in combination with a static or base (non-zero) optical power.

FIGS. 4A and 4B show two states for an illustrative lens system configured to perform vision correction for presbyopia. In particular, lens system 22 may include pair of lenses or lens plates 40 and 42 (as similarly described in connection with FIGS. 2A and 2B). Lens 40 may include opposite surfaces 56 and 58. Surface 56 may be a non-freeform surface such as a planar (e.g., nominally planar) surface. Surface 58 may be a freeform surface of the type described in connection with FIGS. 2 and 3 (e.g., a surface having a sagitta or sag defined by a freeform polynomial function). Lens 42 may include opposite surfaces 60 and 62. Surface 60 may be non-freeform surface such as a planar (e.g., nominally planar) surface. Surface 62 may be a freeform surface of the type described in connection with FIGS. 2 and 3 (e.g., a surface having a sagitta or sag defined by a freeform polynomial function).

In the example of FIG. 4A, surfaces 58 and 62 may face each other and may have respective mating (inverse) surface patterns. Surfaces 58 and 62 may be separated from each other by a gap (e.g., an air gap). If desired, surfaces 58 and 62 may be implemented with corresponding surface patterns that are different and are non-matching (e.g., inverse versions of surfaces 58 and 68 do not match). These differences in the patterns for surfaces 58 and 62 may help provide a larger field of view than if surfaces 58 and 62 have strictly inverse surface patterns.

FIG. 4A shows an aligned state of lens system 22. In this aligned state, objects at far distances (e.g., at infinity, distances greater than 1 m, distances greater than 5 m, etc.) may be appropriately viewable from an eye box behind (overlapping) lens system 22 because parallel light rays passing through lenses 40 and 42 in direction 30 may remain collimated (e.g., lens system 22 does not apply an optical power to passing light) when lenses 40 and 42 are aligned.

The aligned state of FIG. 4A (and of lenses 40 and 42 generally described herein in connection with other FIGS.) may be referred to as a first alignment state between lenses 40 and 42 in which the wavefront transmitted by lens 40 reaches corresponding first locations on lens 42 such that a first optical power (e.g., no optical power, or a base optical power in other embodiments described herein) is imparted through lenses 40 and 42. While edges of lenses 40 and 42 are sometimes shown to be aligned in this first alignment state of lenses 40 and 42, this is merely illustrative. If desired, the edge profiles of lenses 40 and 42 may not necessarily match and/or the lens edges of lenses 40 and 42 may be offset to achieve the optical functionality described in connection with this first alignment state.

FIG. 4B shows an offset state of lens system 22. From the aligned state, lens 40 may move in direction 64 relative to lens 42 and/or lens 42 may move in direction 66 relative to lens 40 to arrive at the offset state. In this offset state, objects at near distances (e.g., distances less than 1 m, distances less than 0.5 m, etc.) may be appropriately viewable from the eye box behind (overlapping) lens system 22 because divergent light rays passing through lenses 40 and 42 in direction 30 may be made less divergent and collimated light is output (e.g., surfaces 58 and/or 62 apply a positive optical power to passing light) when lenses 40 and 42 are offset (e.g., when lens edges of lenses 40 and 42 are offset).

The offset state of FIG. 4B (and of lenses 40 and 42 generally described herein in connection with other FIGS.) may be referred to as a first alignment state between lenses 40 and 42 in which the wavefront transmitted by lens 40 reaches corresponding second locations (different than the above-mentioned first locations) on lens 42 such that a second optical power (e.g., an adjustable power component in combination with the above-mentioned first optical power) is imparted through lenses 40 and 42. While edges of lenses 40 and 42 are sometimes shown to be offset in this second alignment state of lenses 40 and 42, this is merely illustrative. If desired, the edge profiles of lenses 40 and 42 may not necessarily be offset and/or the lens edges of lenses 40 and 42 may be aligned to achieve the optical functionality described in connection with this second alignment state.

Configured in this manner, lens system 22 includes an adjustable presbyopic vision correction component that is provided when freeform surfaces 58 and 62 are offset (FIG. 4B). Surfaces of lens system 22 may provide no base optical power in the aligned state (FIG. 4A).

As described herein, directions 64 and 66 may be parallel to any suitable axis in system 10. As examples, directions 64 and 66 may be horizontal directions (e.g., aligned with an axis of the glasses that extends across left and right lenses), vertical directions, diagonal directions having horizonal and vertical components (e.g., following a diagonal incline of the convergence of the user's eyes during changes in depth).

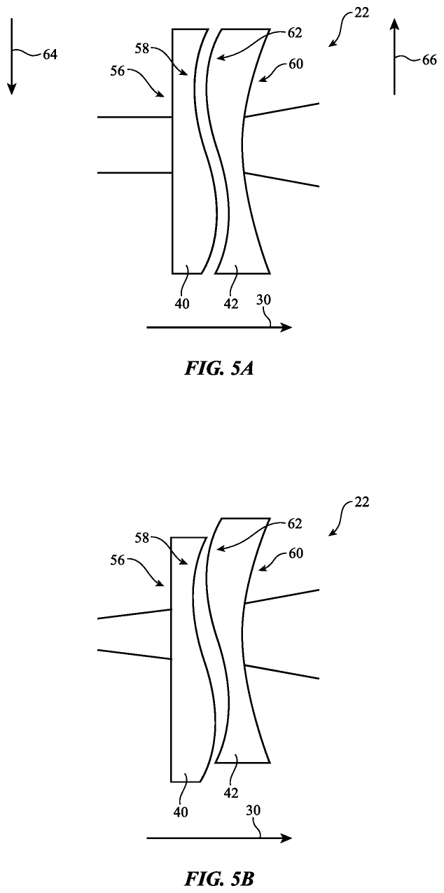

In some configurations described herein as examples, lenses 40 and 42 may be configured to provide a (non-zero) base optical power using base lens shape(s) (e.g., to provide ametropia vision correction corresponding to an ophthalmic prescription) in addition to a tunable optical power by lateral lens movements (e.g., to provide presbyopia vision correction or to form an anti-fatigue lens). In these configurations, even in the normally aligned configuration (e.g., when edges of lenses 40 and 42 are aligned), lenses 40 and 42 may still exhibit a base optical power such as a positive or negative optical power with or without a cylinder component and a corresponding axis for the cylinder component (e.g., to provide ametropia vision correction corresponding an ophthalmic prescription). Various illustrative lens surface(s) into which these additional optical properties for providing a static optical power may be incorporated or integrated into lens system 22 (e.g., as part of lens surfaces 56, 58, 60, and/or 62) are further detailed in connection with FIGS. 5-9.

FIGS. 5A and 5B show two states for an illustrative lens system having a non-freeform back surface that provides the base or static optical power (e.g., with or without a cylinder component and a corresponding axis for the cylinder component). As shown in FIGS. 5A and 5B, back surface 60 of lens 42 may be a concave surface. Back surface 60 may be the surface closest (of surfaces 56, 58, 60, and 62) to and facing an eye box that receives a user's eye 16 (FIG. 1). Back surface 60 may be a non-freeform concave surface having a surface shape that is spherical, aspherical, toric, atoric, or any combination these shapes (e.g., that has one or more spherical, aspherical, toric, and/or atoric surface components at various surface portions and/or combined at the same surface portion). The other surfaces 56, 58, and 62 may have the same configuration as those described in connection with FIGS. 4A and 4B. Accordingly, back surface 60 may provide an ametropic vision correction component (e.g., a myopic vision correction component) for lens system 22 while freeform surfaces 58 and 62 provide an adjustable presbyopic vision correction component for lens system 22.

FIG. 5A shows an aligned state of lens system 22. In this aligned state, objects at far distances (e.g., at infinity, distances greater than 1 m, distances greater than 5 m, etc.) may be appropriately viewable from the eye box behind (overlapping) lens system 22 because parallel light rays passing through lenses 40 and 42 in direction 30 may be made more divergent and diverging light may be output when lenses 40 and 42 are aligned (e.g., when lens edges of lenses 40 and 42 are aligned). In other words, surface 60 applies a static negative optical power to passing light.

FIG. 5B shows an offset state of lens system 22. From the aligned state in FIG. 5A, lens 40 may move in direction 64 relative to lens 42 and/or lens 42 may move in direction 66 relative to lens 40 to arrive at the offset state. In this offset state, objects at near distances (e.g., distances less than 1 m, distances less than 0.5 m, etc.) may be appropriately viewable from the eye box behind (overlapping) lens system 22 because divergent light rays passing through lenses 40 and 42 in direction 30 may be made more convergent and (less) divergent light is output when lenses 40 and 42 are offset (e.g., when lens edges of lenses 40 and 42 are offset). In other words, surfaces 58 and 62 apply a second adjustable positive optical power on top of (e.g., in combination with) the first static negative optical power provided by surface 60 to passing light.

Configured in this manner, surface 60 of lens system 22 provides a base diverging optical power component for ametropic (e.g., myopic) vision correction in both the aligned state (FIG. 5A) and the offset state (FIG. 5B). Freeform surfaces 58 and 62 of lens system 22 selectively provide an adjustable converging optical power component for presbyopic vision correction (on top of the base diverging optical power) when freeform surfaces 58 and 62 are offset (FIG. 5B).

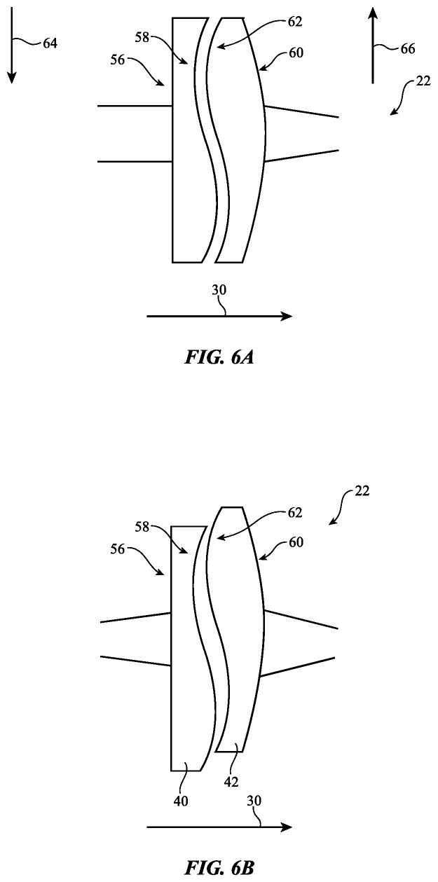

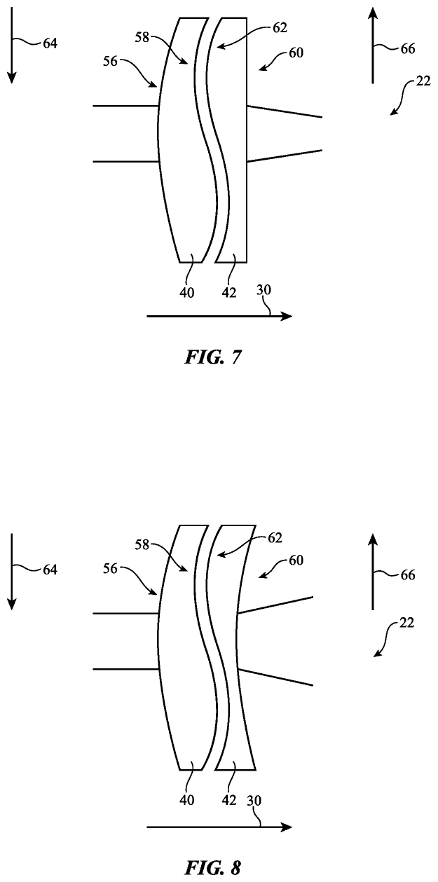

In another illustrative configuration, back surface 60 may be a convex surface. In particular, FIGS. 6A and 6B show two states for an illustrative lens system having a non-freeform back surface that provides the base or static optical power (e.g., with or without a cylinder component and a corresponding axis for the cylinder component). As shown in FIGS.

6A and 6B, back surface 60 of lens 42 may be a convex surface. Back surface 60 may be the surface closest (of surfaces 56, 58, 60, and 62) to an eye box that receives a user's eye 16 (FIG. 1). Back surface 60 may be a non-freeform convex surface having a surface shape that is spherical, aspherical, toric, atoric, or any combination these shapes (e.g., that has one or more spherical, aspherical, toric, and/or atoric surface components at various surface portions and/or combined at the same surface portion). The other surfaces 56, 58, and 62 may have the same configuration as those described in connection with FIGS. 4A and 4B. Accordingly, back surface 60 may provide an ametropic vision correction component (e.g., a hyperopic vision correction component) for lens system 22 while freeform surfaces 58 and 62 provide an adjustable presbyopic vision correction component for lens system 22.

FIG. 6A shows an aligned state of lens system 22. In this aligned state, objects at far distances (e.g., at infinity, distances greater than 1 m, distances greater than 5 m, etc.) may be appropriately viewable from the eye box behind (overlapping) lens system 22 because parallel light rays passing through lenses 40 and 42 in direction 30 may be made more convergent and converging light may be output when lenses 40 and 42 are aligned (e.g., when lens edges of lenses 40 and 42 are aligned). In other words, surface 60 applies a static positive optical power to passing light.

FIG. 6B shows an offset state of lens system 22. From the aligned state in FIG. 6A, lens 40 may move in direction 64 relative to lens 42 and/or lens 42 may move in direction 66 relative to lens 40 to arrive at the offset state. In this offset state, objects at near distances (e.g., distances less than 1 m, distances less than 0.5 m, distances less than 0.1 m, etc.) may be appropriately viewable from the eye box behind (overlapping) lens system 22 because divergent light rays passing through lenses 40 and 42 in direction 30 may be made more convergent and converging light is output when lenses 40 and 42 are offset (e.g., when lens edges of lenses 40 and 42 are offset). In other words, surfaces 58 and 62 apply a second adjustable positive optical power on top of (e.g., in combination with) the first static positive optical power provided by surface 60 to passing light.

Configured in this manner, surface 60 of lens system 22 provides a base converging optical power component for ametropic (e.g., hyperopic) vision correction in both the aligned state (FIG. 6A) and the offset state (FIG. 6B). Freeform surfaces 58 and 62 of lens system 22 selectively provide an adjustable converging optical power component for presbyopic vision correction (on top of the base converging optical power) when freeform surfaces 58 and 62 are offset (FIG. 6B).

In another illustrative configuration, a different surface of lens system 22 such as front surface 56 may provide a base optical power component. In particular, FIG. 7 shows an illustrative lens system having a non-freeform front surface that provides the base (static) optical power (e.g., with or without a cylinder component and a corresponding axis for the cylinder component). In the example of FIG. 7, front surface 56 of lens 42 may be a convex surface. Front surface 56 may be the surface farthest (of surfaces 56, 58, 60, and 62) to an eye box that receives a user's eye 16 (FIG. 1). Front surface 56 may be a non-freeform convex surface having a surface shape that is spherical, aspherical, toric, atoric, or any combination these shapes (e.g., that has one or more spherical, aspherical, toric, and/or atoric surface components at various surface portions and/or combined at the same surface portion). The other surfaces 58, 60, and 62 may have the same configuration as those described in connection with FIGS. 4A and 4B. Accordingly, front surface 56 may provide an ametropic vision correction component (e.g., a hyperopic vision correction component) for lens system 22 while freeform surfaces 58 and 62 provide an adjustable presbyopic vision correction component for lens system 22.

FIG. 7 shows an aligned state of lens system 22. In this aligned state, objects at far distances (e.g., at infinity, distances greater than 1 m, distances greater than 5 m, etc.) may be appropriately viewable from the eye box behind (overlapping) lens system 22 because parallel light rays passing through lenses 40 and 42 in direction 30 may be made more convergent and converging light may be output when lenses 40 and 42 are aligned (e.g., when lens edges of lenses 40 and 42 are aligned). In other words, surface 56 applies a static positive optical power to passing light.

From the aligned state in FIG. 7, lens 40 may move in direction 64 relative to lens 42 and/or lens 42 may move in direction 66 relative to lens 40 to arrive at an offset state. In the offset state, objects at near distances (e.g., distances less than 1 m, distances less than 0.5 m, distances less than 0.1 m, etc.) may be appropriately viewable from the eye box behind (overlapping) lens system 22 because divergent light rays passing through lenses 40 and 42 in direction 30 may be made more convergent and converging light is output when lenses 40 and 42 are offset (e.g., when lens edges of lenses 40 and 42 are offset). In other words, surfaces 58 and 62 apply a second adjustable positive optical power on top of (e.g., in combination with) the first static positive optical power provided by surface 56 to passing light.

Configured in this manner, surface 56 of lens system 22 provides a base converging optical power component for ametropic (e.g., hyperopic) vision correction in both the aligned state and the offset state. Freeform surfaces 58 and 62 of lens system 22 selectively provide an adjustable converging optical power component for presbyopic vision correction (on top of the base converging optical power) when freeform surfaces 58 and 62 are offset.

While a positive base optical power is provided by a convex front surface (e.g., to correct for hyperopia) in the example of FIG. 7, this is merely illustrative. If desired, front surface 56 may be a concave surface that provides a negative base optical power (e.g., to correct for myopia). In particular, front surface 56 may be a non-freeform concave surface having a surface shape that is spherical, aspherical, toric, atoric, or any combination these shapes (e.g., that has one or more spherical, aspherical, toric, and/or atoric surface components at various surface portions and/or combined at the same surface portion).

If desired, a combination of surfaces may be used to provide the base (static) optical power for lens system 22. In one illustrative arrangement shown in FIG. 8, front surface 56 of lens 40 may be a convex surface with a first base shape (e.g., a spherical, aspherical, toric, and/or atoric shape) and back surface 60 of lens 42 may be a concave surface with an additional base shape (e.g., a spherical, aspherical, toric, and/or atoric shape) that supplements the first base shape to provide the desired overall static optical properties across the lens stack (e.g., lens pair). Accordingly, front surface 56 and back surface 60 may provide an ametropic vision correction component (e.g., a myopic vision correction component with or without an astigmatic vision correction component) for lens system 22 while freeform surfaces 58 and 62 provide an adjustable presbyopic vision correction component for lens system 22. The other surfaces 58 and 62 may have the same configuration as those described in connection with FIGS. 4A and 4B.

FIG. 8 shows an aligned state of lens system 22. In this aligned state, objects at far distances (e.g., at infinity, distances greater than 1 m, distances greater than 5 m, etc.) may be appropriately viewable from the eye box behind (overlapping) lens system 22 because parallel light rays passing through lenses 40 and 42 in direction 30 may be made more divergent and diverging light may be output when lenses 40 and 42 are aligned (e.g., when lens edges of lenses 40 and 42 are aligned). In other words, surfaces 56 and 60 apply a static negative optical power to passing light.

From the aligned state in FIG. 8, lens 40 may move in direction 64 relative to lens 42 and/or lens 42 may move in direction 66 relative to lens 40 to arrive at an offset state. In the offset state, objects at near distances (e.g., distances less than 1 m, distances less than 0.5 m, distances less than 0.1 m, etc.) may be appropriately viewable from the eye box behind (overlapping) lens system 22 because divergent light rays passing through lenses 40 and 42 in direction 30 may be made more convergent and (less) divergent light is output when lenses 40 and 42 are offset (e.g., when lens edges of lenses 40 and 42 are offset). In other words, surfaces 58 and 62 apply a second adjustable positive optical power on top of (e.g., in combination with) the first static negative optical power provided by surfaces 56 and 60 to passing light.

Configured in this manner, surfaces 56 and 60 of lens system 22 provide a base diverging optical power component for ametropic (e.g., myopic) vision correction in both the aligned state and the offset state. Freeform surfaces 58 and 62 of lens system 22 selectively provide an adjustable converging optical power component for presbyopic vision correction (on top of the base diverging optical power) when freeform surfaces 58 and 62 are offset.

The configurations of lens surfaces 56 and 60 in FIG. 8 are merely illustrative. If desired, surfaces 56 and 60 may have any other suitable shape to provide a static optical power for other types of ametropic correction (e.g., correction for hyperopia, astigmatism, etc.) or generally provided a desired base optical power with or without a base cylinder component and a corresponding axis for the base cylinder component. As an example, lens surface 56 may be a concave surface and/or lens surface 60 may be a convex surface (e.g., instead of the configurations shown in FIG. 8).

By providing non-freeform surface(s) having these additional surface optical properties, lenses 40 and 42 may be configured to provide correction for ametropia (e.g., provide distance vision correction optical power and/or cylinder) in addition to providing an adjustable optical power and cylinder based on lateral lens shifts or translations. While non-freeform (front and/or back) surfaces are shown in FIGS. 5-8 to exhibit the above-mentioned additional optical properties for distance vision correction, this is merely illustrative. If desired, other surface(s) of lens 40 and/or lens 42 may exhibit these additional surface optical properties for ametropic correction.

In some arrangements, freeform surfaces of lenses 40 and 42 exhibiting adjustable added (diverging or converging) optical power based on the lateral translation of lenses 40 and 42 may also include surface components (as part of the freeform surfaces) that themselves provide the base optical power for ophthalmic use (e.g., to correct for ametropia) in addition to the adjustable added optical power. In these arrangements, respective freeform surfaces of lenses 40 and 42 may be different or unique with respect to each other (e.g., may not necessarily be complementary or inverse version of each other even in the aligned configuration). In other words, opposing points on the opposing freeform surfaces may be separated by a gap of varying distances.

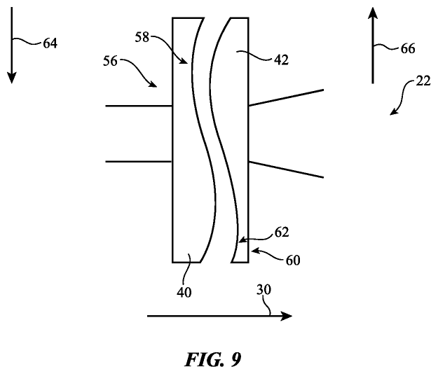

In one illustrative arrangement shown in FIG. 9, one or both of freeform surfaces 58 and 62 may each include one or more spherical, aspherical, toric, and atoric components. In other words, spherical, aspherical, toric, and/or atoric surface features may be integrated with the freeform surface (e.g., defined by or as part of the X-Y polynomials and/or Zernike polynomials) such that the resulting surface includes freeform surface components and non-freeform surface components (e.g., spherical components, aspherical components, toric components, atoric components, etc.). As one illustrative example, one or both of freeform surfaces 58 and 62 may have a base shape (e.g., a spherical, aspherical, toric, and/or atoric shape) on top of which the freeform surface is subsequently formed (e.g., patterned). The other surfaces 56 and 60 may have the same configuration as those described in connection with FIGS. 4A and 4B.

FIG. 9 shows an aligned state of lens system 22. In this aligned state, objects at far distances (e.g., at infinity, distances greater than 1 m, distances greater than 5 m, etc.) may be appropriately viewable from the eye box behind (overlapping) lens system 22 because parallel light rays passing through lenses 40 and 42 in direction 30 may be made more divergent and diverging light may be output when lenses 40 and 42 are aligned (e.g., when lens edges of lenses 40 and 42 are aligned). In other words, surfaces 58 and/or 62 apply a static negative optical power to passing light.

From the aligned state in FIG. 9, lens 40 may move in direction 64 relative to lens 42 and/or lens 42 may move in direction 66 relative to lens 40 to arrive at an offset state. In the offset state, objects at near distances (e.g., distances less than 1 m, distances less than 0.5 m, distances less than 0.1 m, etc.) may be appropriately viewable from the eye box behind (overlapping) lens system 22 because divergent light rays passing through lenses 40 and 42 in direction 30 may be made more convergent and (less) divergent light is output when lenses 40 and 42 are offset (e.g., when lens edges of lenses 40 and 42 are offset). In other words, surfaces 58 and 62 apply a second adjustable positive optical power on top of (e.g., in combination with) the first static negative optical power provided by surfaces 58 and 62 (present across both the aligned and offset states) to passing light.

Configured in this manner, freeform surfaces 58 and 62 of lens system 22 provide a base diverging optical power component for ametropic (e.g., myopic with or without asigmatic) vision correction in the aligned state and selectively provides an adjustable converging optical power component for presbyopic vision correction (on top of the base diverging optical power) when freeform surfaces 58 and 62 are offset.

The configurations of lens surfaces 58 and 62 in FIG. 9 are merely illustrative. If desired, surfaces 58 and 62 may have any other suitable shape to provide a static optical power for ametropic correction. As an example, lens surfaces 58 and 62 may provide a base converging or positive optical power component (e.g., instead of the negative optical power configuration described in connection with FIG. 9) having a cylinder component and a corresponding axis for the cylinder component. If desired, surfaces 56 and/or 60 may provide an additional static optical power to supplement the static optical power provided by surfaces 58 and 62 for ametropic correction.

In configurations in which only one of the freeform surfaces of the lens stack (e.g., surface 58 of lens 40 or surface 62 of lens 42) includes the base lens shape (e.g., a spherical, aspherical, toric, and/or atoric shape) to provide static distance vision correction, the freeform surface that includes the base lens shape may be on the non-moving or stationary lens in the lens stack (e.g., the lens that is held in place or not moved while the other lens shifts laterally, the lens that is not coupled to one or more actuators for movement, etc.).

In configurations sometimes described herein as an example, the base lens shape (e.g., a spheric, aspheric, toric, or atoric shape) added to lens 40 and/or 42 to provide distance vision correction (e.g., ametropic vision correction for an ophthalmic prescription) may be provided on a non-freeform or freeform lens surface of a non-moving lens in the lens pair. As an example, if lens 42 is configured to be moved (e.g., by one or more actuators), a lens surface of lens 40 (e.g., front lens surface 56) may be provided with the base lens shape for distance vision correction (e.g., a spheric, aspheric, toric, or atoric shape).

If desired, a non-freeform surface of the stationary lens (e.g., one of lens 40 or lens 42) and/or the base optical power component of the freeform surface of the stationary lens may have a progressive lens surface pattern (e.g., that provides progressive or differing optical powers at different lens regions), thereby facilitating progressive vision correction and/or other desired optical system characteristics (e.g., to reduce lens stack thickness, to reduce lens plate translational range, etc.).

The surface configurations for lenses 40 and 42 as described in connection with FIGS. 2-9 show some illustrative examples for providing a static or base optical power component and an adjustable optical power or other characteristics. In general, any one or more of surfaces 56, 58, 60, and 62 may provide base optical power, and any one or more of surfaces 56, 58, 60, and 62 may be freeform surfaces. Freeform and/or non-freeform surfaces may provide the base optical power.

If desired, one or both of inner or outer surfaces 56 and 60 may be a freeform surface instead of or in addition to one or both of surfaces 58 and 62 being freeform surfaces (e.g., as described in connection with FIGS. 2 and 4-9).

In some applications and/or implementations, it may be desirable to provide a base distance correction component (e.g., ametropic correction component) as part of one or both freeform surfaces of each of lenses 40 and 42. In other words, in a first lateral alignment state, the freeform surfaces may provide a base distance correction component and, in one or more additional lateral alignment states, the freeform surfaces may provide one or more corresponding additional optical component (e.g., variable optical power based on lateral alignment) on top of the base distance correction component. As an example, lenses 40 and 42 of this type (e.g., in FIG. 9), may be coupled to a housing frame or a glasses frame having a pantoscopic tilt and/or wrap angle.

FIGS. 10A and 10B show two aligned and offset states for an illustrative lens configuration that mitigates movement-induced prism (e.g., prism introduced when one of lens 40 or lens 42 is moved relative to the other lens). In particular, when a lens is shifted laterally (e.g., moved downward in direction 64 or upward in direction 66), prism may be introduced because the user's gaze may not intersect with the surface vertex (as it does when the lenses are aligned).

In order to mitigate the introduced prism, a lens system such as lens system 22 in FIGS. 10A and 10B may include lenses 40 and 42 having middle (freeform) surfaces with cylinders (e.g., defined by polynomial terms for the freeform surfaces of lenses 40 and 42) configured or tuned to introduce opposing prism to counteract the effects of the movement-introduced prism in the offset state.

As shown in FIG. 10A, lens 40 may include surface 58 (e.g., a freeform surface). Surface 58 may be configured to introduce an opposing prism at region 68 of surface 58 such that when lens 40 moves in direction 66 and is shifted laterally to arrive at the offset state shown in FIG. 10B, the opposing prism introduced by surface 58 at region 68 may counteract (e.g., negate) the effects of the prism introduced by the movement of lens 40. If desired, surface 62 (e.g., a freeform surface) may also be configured to introduce the opposing prism (e.g., in combination with surface 58).

If desired, this type of dynamic prism (e.g., prism introduced by the dynamic movement of lens components) may be reduced or minimized by moving the lens configured to impart the lesser base optical power (e.g., a lens with a nominally planar non-freeform surface that does not apply a base optical power). In other words, one or more actuators may be coupled to and configured to move a lens in the lens stack that imparts the lesser base optical power while the lens in the lens stack that imparts the greater base optical power is fixed or stationary (e.g., relative to head-mounted support structure 12 of device 14). As an example in connection with FIGS. 5A and 5B or FIGS. 6A and 6B, lens 40 (with a relatively flat surface 56) may be moved laterally in direction 64 while lens 42 (with a higher curvature surface 60) remains fixed in position relative to the head-mounted housing frame to reduce an undesired dynamic prism effect. As an example in connection with FIG. 7, lens 42 (with a relatively flat surface 60) may be moved laterally in direction 66 while lens 40 (with a higher curvature surface 56) remains fixed in position relative to the head-mounted housing frame to reduce an undesired dynamic prism effect. As an example in connection with FIG. 8, lens 40 (e.g., with a lower curvature surface 56) may be moved laterally in direction 64 while lens 42 (with a higher curvature surface 60) remains fixed in position relative to the head-mounted housing frame to reduce an undesired dynamic prism effect.

If desired, this type of dynamic prism may be (further) reduced or minimized by laterally translating the moving lens towards the nasal region (e.g., toward the nose bridge region of head-mounted support structure 12) when adding optical power and/or by decreasing translation magnitude.

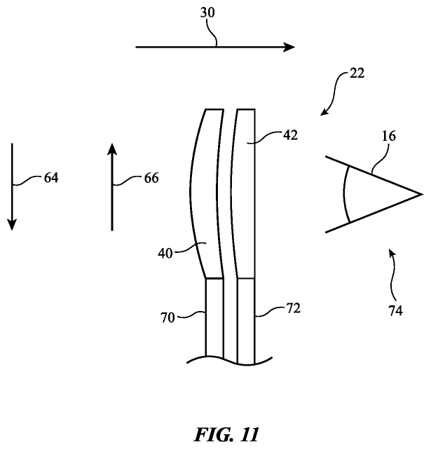

FIG. 11 is a diagram of an illustrative actuating system coupled to an illustrative set of lenses received within an opening of the head-mounted housing frame of structure 12. The actuating system such as one or more actuators may be coupled to one or both lenses to laterally shift one or both lenses relative to each other. In the example of FIG. 11, lenses 40 and 42 may be mounted within the head-mounted housing frame of structure 12 (e.g., a left or right opening) and may overlap an eye box 74 (e.g., a left or right eye box) in which eye 16 is received. Another set of lenses may be similarly provided for the other eye box in which the other eye is received. Lenses 40 and 42 in FIG. 11 may be any of the lenses 40 and 42 described in connection with FIGS. 2-10.

One or more actuators may be coupled to one or both of lenses 40 and 42 and may be configured to shift lenses 40 and/or 42 in directions 64 and/or 66 as needed to change between the aligned and offset states. In the illustrative example of FIG. 11, one or more actuators 70 may be coupled to lens 40, while one or more actuators 72 may be coupled to lens 42. While both lenses may be coupled to actuators, control circuitry 26 may control only one of the two lenses to move (e.g., to reduce an undesired prism effect). Providing both lenses with the capability for shifting (e.g., lateral movement) may increase flexibility of device 14 to receive different lenses (e.g., lenses with different degrees of base curvature) in different locations while still reducing undesired prism (by moving the appropriate one of the lenses). If desired, one of lenses 40 and 42 may be a static or stationary lens fixed in position within the head-mounted housing frame (e.g., the corresponding actuator(s) 70 or 72 may be omitted).

The foregoing is merely illustrative and various modifications can be made to the described embodiments. The foregoing embodiments may be implemented individually or in any combination.

What is claimed is:

1. A head-mounted device comprising:
a support structure;
first and second lenses that are coupled to the support structure and that overlap each other, wherein one or more objects are viewable through the first and second lenses from an eye box; and
an actuator coupled to the first lens and configured to laterally shift the first lens relative to the second lens to switch between an aligned configuration and an offset configuration, wherein the first and second lenses comprise an adjustable vision correction component and a static vision correction component.

2. The head-mounted device defined in claim 1, wherein the first lens comprises a freeform surface and the second lens comprises a freeform surface that faces the freeform surface of the first lens and wherein the freeform surfaces of the first and second lenses provide the adjustable vision correction component.

3. The head-mounted device defined in claim 2, wherein the second lens comprises a non-freeform surface opposite the freeform surface of the second lens and wherein the non-freeform surface provides the static vision correction component.

4. The head-mounted device defined in claim 3, wherein the non-freeform surface is a spherical surface, an aspherical surface, a toric surface, or an atoric surface.

5. The head-mounted device defined in claim 4, wherein the non-freeform surface is a convex surface.

6. The head-mounted device defined in claim 5, wherein the non-freeform surface is a concave surface.

7. The head-mounted device defined in claim 3, wherein the first lens comprises a non-freeform surface opposite the freeform surface of the first lens and wherein the non-freeform surfaces of the first and second lenses provide the static vision correction component.

8. The head-mounted device defined in claim 7, wherein the non-freeform surface of the first lens has a smaller degree of curvature than the non-freeform surface of the second lens.

9. The head-mounted device defined in claim 8, wherein the non-freeform surface of the first lens is a planar surface.

10. The head-mounted device defined in claim 3, wherein the first lens comprises a non-freeform surface opposite the freeform surface of the first lens and wherein the non-freeform surface of the second lens is closer to the eye box than the non-freeform surface of the first lens.

11. The head-mounted device defined in claim 3, wherein the first lens comprises a non-freeform surface opposite the freeform surface of the first lens and wherein the non-freeform surface of the first lens is closer to the eye box than the non-freeform surface of the second lens.

12. The head-mounted device defined in claim 2, wherein the freeform surface of the second lens or an additional freeform surface of the second lens opposite the freeform surface of the second lens provides the static vision correction component.

13. An electronic device comprising:
a head-mounted housing structure; and
a lens system comprises first and second lenses configured to provide a base optical power, wherein the first and second lenses comprise first and second opposing freeform surfaces that are laterally shifted to provide an additional optical power in combination with the base optical power.

14. The electronic device defined in claim 13, wherein the first and second lenses apply the base optical power to passing light when the first and second lenses are in an aligned state and wherein the first and second lenses apply the combination of the base optical power and the additional optical power when the first and second lenses are in an offset state after a lateral shift from the aligned state.

15. The electronic device defined in claim 13, wherein the first and second lenses comprise third and fourth non-freeform surfaces and wherein the base optical power is provided using at least one of the first, second, third, and fourth surfaces of the first and second lenses.

16. The electronic device defined in claim 13, wherein the base optical power is a negative optical power and wherein the additional optical power is a positive optical power.

17. The electronic device defined in claim 13, wherein the base optical power is a positive optical power and wherein the additional optical power is another positive optical power.

18. A lens system comprising:
a first lens having a non-freeform surface and a freefrom surface; and
a second lens having a non-freeform surface facing the away from the non-freeform surface of the first lens and a freeform surface facing the freeform surface of the second lens, wherein the first and second lenses are configured to laterally shift to provide an adjustable optical power, wherein at least a portion of the freeform surface of the first lens exhibits symmetry across a line bisecting the first lens.

19. The lens system defined in claim 18, wherein the first and second lenses are configured to correct for presbyopia using the adjustable optical power.

20. The lens system defined in claim 19, wherein the first and second lenses are configured to provide a base optical power using at least one of the non-freeform surface of the first lens, the freeform surface of the first lens, the non-freeform surface of the second lens, and the freeform surface of the second lens.
